(19) United States
(12) Patent Application Publication
(10) Pub. No.: US 2014/0157961 A1
(43) Pub. Date: Jun. 12, 2014

(54) IMPACT RATCHET WRENCH

(71) Applicant: Chervon (HK) Limited, Wanchai (HK)

(72) Inventor: Liang Chen, Nanjing (CN)

(73) Assignee: Chervon (HK) Limited, Wanchai (HK)

(21) Appl. No.: 13/932,220

(22) Filed: Jul. 1, 2013

(30) Foreign Application Priority Data
Jul. 2, 2012 (CN) 201210222601.8

(51) Int. Cl. B25B 21/00; B25B 21/02

(52) U.S. Cl. CPC B25B 21/004; B25B 21/02
USPC 81/464; 173/93; 173/47

(57) ABSTRACT

An impact ratchet wrench includes a motor assembly, a transmission assembly, an impact assembly and a ratchet assembly which are arranged in a housing and connected with each other in turn. The motor assembly drives the transmission assembly and the transmission assembly includes a cylindrical gear train for providing an output at a first rotating speed or a second rotating speed lower than the first rotating speed. The impact assembly includes a striking member that is driven by the transmission assembly and an output member. The striking member of the impact assembly provides an increasing torque to the output member intermittently to drive the ratchet assembly.

### RELATED APPLICATION INFORMATION

This application claims the benefit of CN 201210222601.8, filed on Jul. 2, 2012, the disclosure of which is incorporated herein by reference in its entirety.

### FIELD OF THE DISCLOSURE

The present invention relates to fastening tools and, more particularly, to a ratchet wrench.

### BACKGROUND

When fastening or releasing a fastener, tools such as manually operated ratchet wrenches or pneumatically operated ratchet wrenches are generally utilized to save manpower time and to meet the torque requirements. However, known ratchet wrenches all have some problems such as inconvenient usage, insufficient torque, inefficient working efficiency and/or the like. These problems thus negatively affect the application ranges of such tools.

### SUMMARY

The following describes an impact ratchet wrench which is relatively small and portable and which has a relatively large torque and wide application range. The impact ratchet wrench as described hereinafter may be carried for use in outdoor, basement, narrow, and/or other spaces.

By way of example only, the following describes a ratchet wrench having a housing, wherein the impact ratchet wrench further includes a motor assembly, a transmission assembly, an impact assembly and a ratchet assembly which are arranged in the housing and connected with each other in turn. The motor assembly is connected to the transmission assembly, the transmission assembly includes a cylindrical gear train by which a first rotating speed or a second rotating speed lower than the first rotating speed is transmitted. The impact assembly includes a striking member and an output member. The striking member is capable of providing an increasing torque to the output member intermittently.

The ratchet assembly may include a swinging member and a supporting member for forcing a ratchet to rotate with the swinging motion of the swinging member.

The ratchet assembly may include a ratchet defining a through-hole for receiving a fastener piece, the ratchet being forced to rotate by the swinging member driven by the output member.

The transmission assembly may include two transmission trains formed by gears having a different number of teeth whereupon the rotating speeds transmitted by the two transmission trains are respectively the first rotating speed and the second rotating speed.

The transmission assembly may include a motor gear connected to an output shaft of the motor assembly whereupon the gears in the two transmission trains are engaged with the motor gear and transmit the first rotating speed or the second rotating speed.

The transmission assembly may include a one-way clutch such that, when the one-way clutch is in a locked state, the output shaft transmits the second rotating speed to the impact assembly, and when the one-way clutch is in an overrunning state, the output shaft transmits the first rotating speed to the impact assembly.

The impact assembly may include a shaft mated with the striking member and the output member with the shaft being connected to the output shaft to rotate at a rotating speed transmitted by the output shaft.

The striking member and the output member may be provided with projections stopped by each other at the jointing surface of the striking member and the output member.

The output member may include an extending part arranged in an eccentric position and extending into the ratchet assembly.

The impact ratchet wrench may include a battery assembly connected to the motor assembly for providing power to the motor assembly.

As compared with known devices, the impact ratchet wrench described hereinafter provides a relatively large torque as required for locking bolts by virtue of the impact assembly and provides a relatively larger locking force. In addition, the ratchet structure at the head part of the subject impact wrench has a relatively small size which allows the device to be used in more working conditions. The impact ratchet wrench is preferably powered by a battery and has a relatively small overall structure thus making it portable and suitable for carrying.

### BRIEF DESCRIPTION OF THE DRAWINGS

FIG. 1 is an isometric view of an exemplary impact ratchet wrench which includes an impact ratchet wrench, an impact assembly, and an transmission assembly;

FIG. 2 is a top view of the impact ratchet wrench of FIG. 1;

FIG. 3 is a sectional view of the impact ratchet wrench of FIG. 2;

FIG. 4 is an exploded, isometric view of the impact ratchet wrench of FIG. 1;

FIG. 5 is an exploded, isometric view of the ratchet assembly of FIG. 2;

FIG. 6 is an exploded, isometric view of the impact assembly of FIG. 2; and

FIG. 7 is an exploded, isometric view of the transmission assembly of FIG. 2.

### DETAILED DESCRIPTION

With reference to the drawings, the following will describe a preferred embodiment of an exemplary impact ratchet wrench. The following descriptions are, however, only intended to explain the technical solutions of the present invention clearly. As such, the following descriptions are not intended to unduly limit the protection scope of the present invention as set forth in claims.

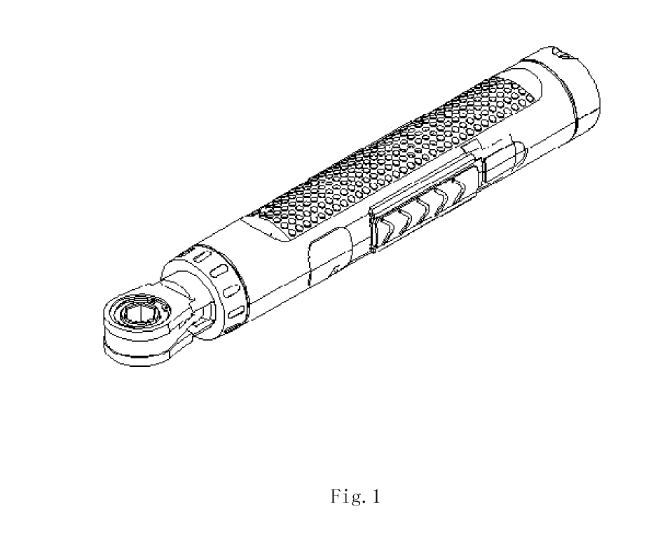

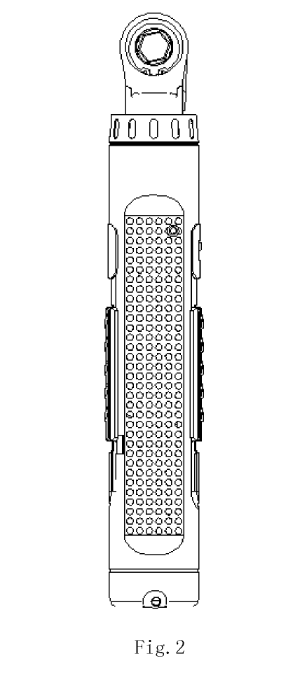

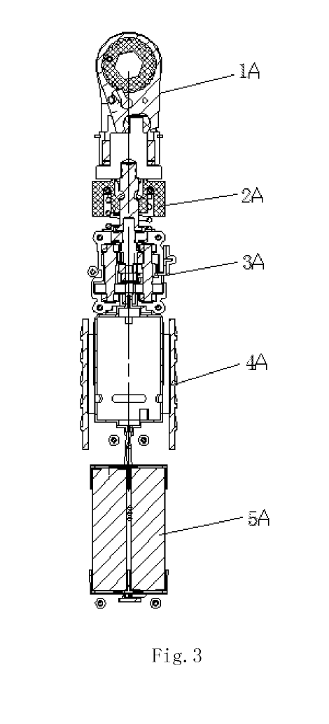

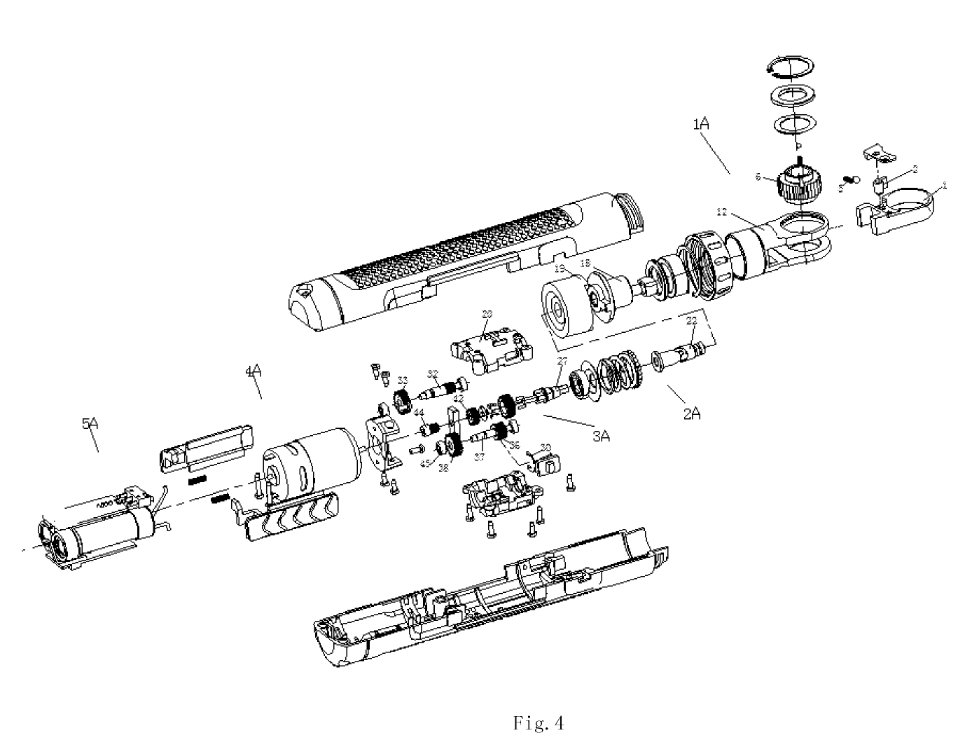

As shown in FIGS. 1-4, one embodiment of the impact ratchet wrench of the present invention includes a battery assembly 5A, a motor assembly 4A, a transmission assembly 3A, an impact assembly 2A, and a ratchet assembly 1A. As will be appreciated, accessories for use with the impact ratchet wrench may also be provided.

The battery assembly 5A is a common rechargeable battery and provides power to the motor assembly 4A. The battery assembly 5A has high efficiency and small size.

The motor assembly 4A includes a DC motor for providing a motive force.

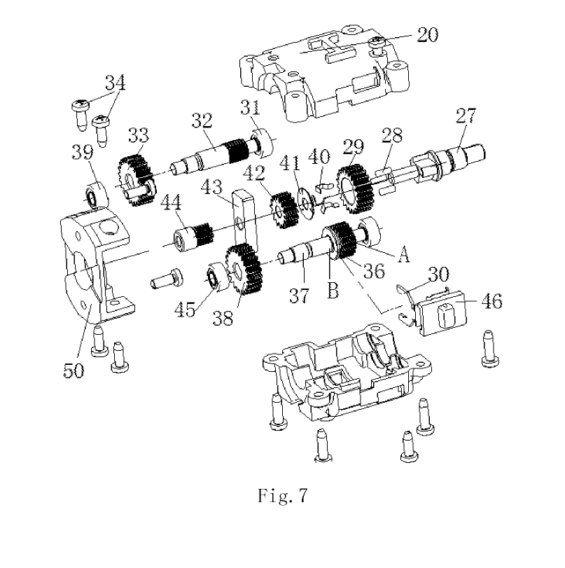

The transmission assembly 3A includes gears engaged with each other where the gears perform the function of switching the transmission ratios for converting the torque of the motor into an available torque. As shown in FIG. 7, a motor gear 44 is connected to an output shaft of the motor in the motor assembly 4A and the motor forces the motor gear 44 to rotate. The transmission assembly 3A includes gears in the form of cylindrical gears and includes two pairs of gears having a different number of teeth, i.e., a first transmission train comprising: the motor gear 44-the gear 33-the gear shaft 32-the gear 29; and a second transmission train comprising: the motor gear 44-the gear 38-the shaft 37-the gear 36-the gear 42. The gear 36 is controlled by a shift fork 30 to move on the shaft 37. When the shift fork 30 is shifted to a position A on the shaft 37, the gear 36 is disengaged from the shaft 37. When the shift fork 30 is moved to a position B on the shaft 37, the gear 36 is fixedly connected to the shaft 37 by a flat portion. The first transmission train intersects with the second transmission train at the gear 36 and the shaft 37, and an interference there between is avoided by the disengagement form.

When the shift fork 30 is shifted to the position A on the shaft 37, the gear 36 is disengaged from the shaft 37, and the machine is in a low-speed operating state. The torque in the gear box 20 is transmitted by the first transmission train. The motor output shaft in the motor assembly 4A forces the motor gear 44 to rotate, and the motor gear 44 and the gear 33 are engaged with each other for transmission. The gear 33 forces the gear shaft 32 to rotate, while the gear shaft 32 and the gear 29 are engaged with each other for transmission. The one-way clutch formed by an output shaft 27, a locking pin 28, the gear 29 and a spring piece 40 is in a locked state. The gear 42 is engaged with the gear 36, while the gear 36 is disengaged from the shaft 37. At this moment, the output speed of the output shaft 27 is the rotating speed of the gear 29, and the output shaft 27 is in the low-speed state.

When the shift fork 30 is shifted to the position B on the shaft 37, the gear 36 is connected with the shaft 37, and the machine is in a high-speed operating state. The torque in the gear box 20 is transmitted by the first transmission train and the second transmission train. However, at the gear 29, since the rotating speed of the first transmission train is lower than that of the second transmission train, the rotating speed of the gear 29 is lower than that of the gear 42, and the output speed of the gear 42 engaged with the output shaft is larger than that of the gear 29. Thus, the one-way clutch formed by the output shaft 27, the locking pin 28, the gear 29 and the spring piece 40 is in an overrunning state. Thus, at this moment, the output speed of the output shaft 27 is the rotating speed of the gear 42, and the output shaft 27 is in the high-speed state.

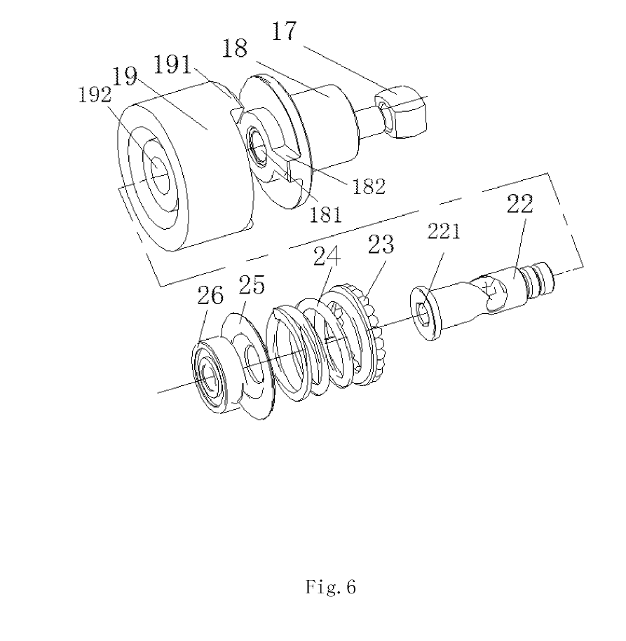

The impact assembly 2A includes a striking member and an output member, the striking member is capable of providing an increasing torque to the output member intermittently. In this embodiment, the striking member is an impacting block 19, and the output member is a striking shaft 18, for forcing the ratchet 6 in the ratchet assembly 1A to rotate, as shown in FIG. 6.

The impact assembly 2A utilizes the function of energy storage of a spring 24. The impact assembly 2A includes a shaft 22 formed with a concave track having an inclining slot shape. When an external torque is larger than the predetermined torque, the impact assembly 2A starts to work and provides an impacting torque to the ratchet assembly 1A. The impact structure mainly includes a sliding bearing 17, the striking shaft 18, the impacting block 19, the shaft 22, a steel ball 23, the spring 24, and a bearing 26. With the connection between the impacting block 19 and the steel ball 23, the sliding friction is changed into rolling friction, and the impacting block 19 is pressed and supported by the spring 24. The output shaft 27 in the transmission assembly 3A is supported by the bearing 26. The end of the output shaft 27 is mounted to a blind hole 221 in one end of the shaft 22. Thus, the output shaft 27 can force the shaft 22 to rotate so that the shaft 22 rotates at a rotating speed transmitted by the output shaft 27. The spring 24 surrounds the shaft 22 with one end abutting against the gear box 20 by a gasket 25 and the other end arranged in a groove 192 in the outer wall of the impacting block 19. The other end of the shaft 22 passes through the impacting block 19 and enters into a blind hole 181 in one end of the striking shaft 18.

The impacting block 19 has two projections 191 for mating with the striking shaft 18. The end surface of one end of the striking shaft 18 also has a projecting step 182. The end surface of the other end of the striking shaft 18 has an extending part arranged at an eccentric position and extends into the ratchet assembly. In this embodiment, the extending part is the sliding bearing 17.

When the external torque is larger than the predetermined working value, the impacting block 19 is stopped from rotating. The shaft 22 may continue to rotate under the action of the torque transmitted by the output shaft 27, and due to the action of the steel ball in the concave track, the impacting block 19 rotates. The projections 191 on the impacting block 19 and the projecting step 182 on the striking shaft 18 are stopped by each other. The torque continues to increase until the step 182 on the striking shaft 18 is disengaged from the impacting block 19 whereupon the impacting block 19 speeds up under the action of the elastic force of the spring 24 finishing the impacting operation.

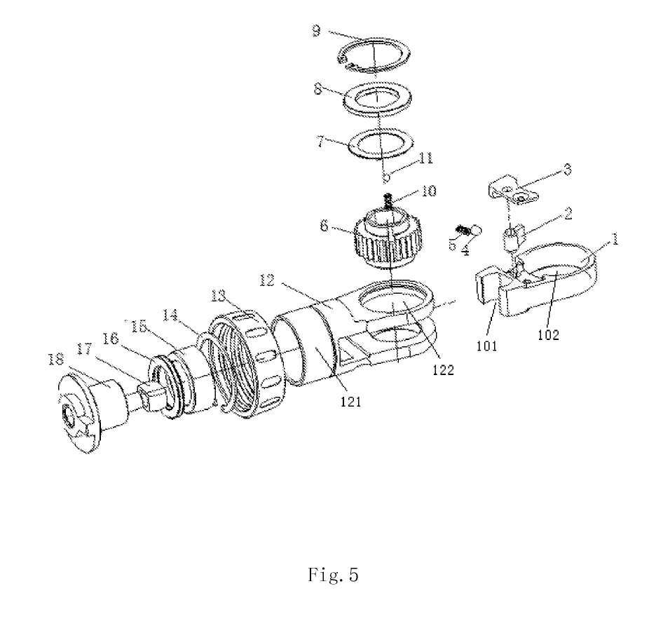

The ratchet assembly 1A can convert the swinging motion into the reciprocating motion in one direction so as to force an accessory to move. The ratchet assembly includes a swinging member 1, a supporting member 2, a swinging block cover 3, a pin 4, springs 5 and 10, a ratchet 6, gaskets 7 and 8, locking rings 9 and 14, a steel ball 11, a supporting housing 12, a locking cover 13, a sliding bearing 15 and a rubber gasket 16. The ratchet 6 defines a through-hole for receiving a fastener piece. The fastener piece may include fasteners such as a bolt and a screw nut, and an accessory sleeve for receiving the fasteners such as a bolt and a screw nut. The output member 18 forces the swinging member 1 to swing so as to force the ratchet 6 to rotate. As shown in FIG. 5, the sliding bearing 15 surrounds the end of the striking shaft 18 having a smaller diameter and contacts the side surface of the end of the striking shaft 18 having a larger diameter by the rubber gasket 16. The supporting member 2 is mounted to the swinging member 1 by the swinging block cover 3 through the pin 4 and the spring 5. The supporting member 2 is mated with one tooth around the ratchet 6, and the supporting member 2 can push the ratchet 6 to rotate with the swinging of the swinging member 1. The swinging member 1 has a U-shaped end 101. The sliding bearing 17 connected with the striking shaft 18 in the impact assembly 2A is positioned in the U-shaped end 101. When the striking shaft 18 rotates, the sliding bearing 17 eccentrically arranged on the striking shaft 18 contacts the two side walls of the U-shaped end 101 of the swinging member 1 so as to force the swinging member 1 to swing. With every swinging motion of the swinging member 1, the supporting member 2 pushes the ratchet 6 to cross one tooth. The supporting housing 12 surrounds the swinging member 1, and the U-shaped end 101 is positioned in a sleeve tube 121 on one end of the supporting housing 12. The locking cover 13 surrounds the sleeve tube 121 on one end of the supporting housing 12, and is locked by the locking ring 14 for preventing disengagement. The supporting housing 12 and the swinging member 1 both includes ring sleeves 122 and 102 for receiving the ratchet 6. The ratchet 6 is fixed into the ring sleeves 122 and 102 of the supporting housing 12 and the swinging member 1 by the spring 10, the steel ball 11, the gaskets 7 and 8 and the locking ring 9.

During operation, when the striking shaft 18 rotates, the swinging member 1 starts to swing in a reciprocation manner under the driving action of the eccentric striking shaft 18, and the supporting member 2 is rotatably connected to the swinging member 1. At this moment, in the positive rotating direction, the supporting member 2 pushes the ratchet 6 to move forwards; when the swinging member 1 moves backwards, the ratchet 6 has a certain friction force under the action of the spring 10 and the relative members. At this moment, the supporting member 2 crosses one tooth of the ratchet 6 under the action of the spring 5 and restores to the initial state to prepare for the next operation for pushing the ratchet 6. Thus, the continuous rotating motion of the ratchet 6 is achieved.

Also, the rotating motion of the machine in the opposite direction is contrary to the above rotating motion, thus the positive and reverse rotations of the machine can be achieved.

The accessory system includes different accessories for connecting the ultimate working pieces such as a bolt and a screw nut so as to force the working pieces to work.

The above contents are the preferred embodiments of the present invention. It should be noted that without departing from the technical principle of the present invention, the person skilled in the art may make some modifications and changes to the present invention, which may be considered as a part of the protection scope of the present invention.

What is claimed is:

1. An impact ratchet wrench comprising:
a housing;
a motor assembly;
a transmission assembly including a cylindrical gear train;
an impact assembly including a striking member and an output member; and
a ratchet assembly;
wherein the motor assembly, the transmission assembly, impact assembly, the ratchet assembly are arranged in the housing and connected with each other in turn with the motor assembly being connected to drive the transmission assembly, the transmission assembly being adapted to transmit a first rotating speed or a second rotating speed lower than the first rotating speed to the impact assembly, the striking member of the impact assembly being driven by the transmission assembly to provide an increasing torque to the output member intermittently, and the output member driving the ratchet assembly.

2. The impact ratchet wrench according to claim 1, wherein the ratchet assembly comprises a swinging member driven by the impact assembly and a supporting member for forcing a ratchet to rotate with the swinging motion of the swinging member.

3. The impact ratchet wrench according to claim 2, wherein the ratchet assembly comprises a ratchet defining a through-hole for receiving a fastener piece and the ratchet is forced to rotate by the swinging member driven by the output member.

4. The impact ratchet wrench according to claim 3, wherein the transmission assembly comprises two transmission trains formed by gears having a different number of teeth and the rotating speeds transmitted by the two transmission trains are respectively the first rotating speed and the second rotating speed.

5. The impact ratchet wrench according to claim 4, wherein the motor assembly includes a DC motor, the transmission assembly comprises a motor gear connected to an output shaft of the DC motor, and the gears in the two transmission trains are engaged with the motor gear and transmit the first rotating speed or the second rotating speed.

6. The impact ratchet wrench according to claim 5, wherein the transmission assembly comprises a one-way clutch and, when the one-way clutch is in a locked state, the output shaft is capable of transmitting the second rotating speed to the impact assembly and, when the one-way clutch is in an overrunning state, the output shaft transmits the first rotating speed to the impact assembly.

7. The impact ratchet wrench according to claim 6, wherein the impact assembly further comprises a shaft engaging with the striking member and the output member and the shaft is connected to the output member to rotate at a rotating speed transmitted by the output shaft.

8. The impact ratchet wrench according to claim 7, wherein the striking member and the output member forms projections that are stopped by each other at adjoining surface of the striking member and the output member.

9. The impact ratchet wrench according to claim 8, wherein the output member comprises an extending part arranged in an eccentric position and extending into the ratchet assembly.

10. The impact ratchet wrench according to claim 1, wherein the impact ratchet wrench further comprises a battery assembly connected to the motor assembly and providing power to the motor assembly.

11. An impact ratchet wrench comprising:
a housing;
a motor assembly including a DC motor received in the housing;
a battery assembly for providing power to the DC motor;
a transmission assembly received in the housing and connected to an output shaft the DC motor, and the transmission assembly including two transmission trains formed by gears having a different number of teeth such that the transmission assembly is capable of transmitting a first rotating speed or a second rotating speed lower than the first rotating speed;
an impact assembly received in the housing and connected the transmission assembly, the impact assembly including a striking member and an output member, the striking member being capable of providing an increasing torque to the output member intermittently; and
a ratchet assembly connected to the output member of the impact assembly.

12. The impact ratchet wrench according to claim 11, wherein the transmission assembly further comprises a motor gear connected to the output shaft of the DC motor and the gears in the two transmission trains are engaged with the motor gear and transmit the first rotating speed or the second rotating speed.

13. The impact ratchet wrench according to claim 12, wherein the transmission assembly further comprises a one-way clutch and, when the one-way clutch is in a locked state, the output shaft is capable of transmitting the second rotating speed to the impact assembly and, when the one-way clutch is in an overrunning state, the output shaft transmits the first rotating speed to the impact assembly.

14. The impact ratchet wrench according to claim 13, wherein the impact assembly further comprises a shaft engaged with the striking member and the output member, and the shaft is connected to the output shaft to rotate at a rotating speed transmitted by the output shaft.

15. The impact ratchet wrench according to claim 14, wherein the striking member and the output member form projections that are stopped by each other at adjoining surfaces of the striking member and the output member.

16. The impact ratchet wrench according to claim 15, wherein the output member comprises an extending part arranged in an eccentric position and extending into the ratchet assembly.
